(19) United States
(12) Patent Application Publication
(10) Pub. No.: US 2004/0052297 A1
(43) Pub. Date: Mar. 18, 2004

(54) Thermal monitoring system

(75) Inventors: Quint McDonald, Santa Cruz, CA (US); Nick Wigen, West Lin, OR (US)

Correspondence Address: LAW OFFICE OF CHARLES E. KRUEGER, P.O. BOX 5607, WALNUT CREEK, CA, 94596-1607, US

(73) Assignee: RAYTEK

(21) Appl. No.: 10/440,453

(22) Filed: May 16, 2003

Related U.S. Application Data
(60) Provisional application No. 60/381,868, filed on May 16, 2002.

(51) Int. Cl. G01J 5/00

(52) U.S. Cl. 374/133; 374/121

(57) ABSTRACT

A thermal monitoring system, including multiple infrared sensors, performs real-time monitoring and alarming for any out of tolerance thermal conditions occurring during a manufacturing process.

### CROSS-REFERENCES TO RELATED APPLICATIONS

This application claims priority the provisional application entitled THERMAL MONITORING SYSTEM, application No. 60/381,868, filed May 1, 2002. The disclosure of which is hereby incorporated by reference for all purposes.

### BACKGROUND OF THE INVENTION

The gypsum wallboard manufacturing process involves the mixing of several dry-mix components with water just prior to flowing the mixture onto the paper and forming it into the final shape. Two of these dry-mix components are a catalyst-accelerator and a retardant. These two components serve to create and control an “exothermic reaction” which forms the crystal structure within the gypsum.

Current technology for monitoring this part of the manufacturing process is via manual sampling and thermocouple measurement of the mixed components. This measurement is generally taken every 30 minutes and takes about 15 minutes to finish. This means that the process can feasibly be out of tolerance for up to 45 minutes without detection. With lost production, materials, labor, and energy all considered, significant losses can result from for a single occurrence. For example, a single occurrence of “soft-set” boards can cause about 45 minutes of downtime with scrap and lost production.

Accordingly, improved techniques for thermal monitoring are needed in the industry. The elimination of just a few “soft set” or “over set” occurrences would result in substantial savings.

### BRIEF SUMMARY OF THE INVENTION

One embodiment of the present invention is a multiple sensor system, which performs real-time monitoring and alarming for any out of tolerance mixer exothermic reaction conditions.

In another embodiment, using a multiple infrared sensor array and Visual Basic software, the system continuously monitors the rise/set temperatures from the mixer slurry in real-time and instantly alarms for any out of tolerance conditions. Replacing traditional manual sample testing and thermocouple measurement of the mixed components, the system eliminates inherent gaps in monitoring the mixing process and detects problems before they cause lost production, labor, and materials.

In another embodiment of the invention, software displays and continuously updates a Time/Temperature graph plotting the readings of the rise temperature sensors and the one final set temperature sensor—thus reproducing the traditional manual thermocouple temperature rise/set chart in real-time and monitoring even subtle changes in the mixer process.

In another embodiment of the invention, each sensor point on the graph has an associated high/low alarm corridor that relates to the target mixer rise/set temperature range, and is automatically activated if the reaction curve moves out of tolerance.

In another embodiment of the invention, software continuously plots readings from each sensor and generates and displays a historical trend chart showing all temperature rise/set variations over time.

In another embodiment of the invention, software receives ambient air temperature data from each sensor location and includes an algorithm for compensation of changes in ambient air temperature. This compensation is factored into the final calculated and graphed variables.

Other features and advantages of the invention will be apparent in view of the following detailed description and appended drawings.

### BRIEF DESCRIPTION OF THE DRAWINGS

FIG. 1 is a block diagram of a preferred embodiment of the invention;

FIG. 2 depicts the hardware components of the system.

FIG. 3 is a depiction of the software display of a real-time temperature rise/set profile chart generated by an embodiment of the invention;

FIG. 4 is a depiction of the software display of historical trend chart generated by an embodiment of the invention; and

FIG. 5 is a table illustrating an example of a temperature compensation algorithm utilized by an embodiment of the invention.

### DETAILED DESCRIPTION OF THE INVENTION

Reference will now be made in detail to various embodiments of the invention. Examples of these embodiments are illustrated in the accompanying drawings. While the invention will be described in conjunction with these embodiments, it will be understood that it is not intended to limit the invention to any embodiment. On the contrary, it is intended to cover alternatives, modifications, and equivalents as may be included within the spirit and scope of the invention as defined by the appended claims. In the following description, numerous specific details are set forth in order to provide a thorough understanding of the various embodiments. However, the present invention may be practiced without some or all of these specific details. In other instances, well known process operations have not been described in detail in order not to unnecessarily obscure the present invention.

An embodiment of the invention will now be described which is a multiple sensor monitoring system, which performs real-time monitoring and alarming for any out of tolerance accelerator/retardant conditions occurring during a gypsum wallboard manufacturing process.

The system components have been designed to work together to provide continuous and reliable mixer monitoring. In this embodiment, eight infrared rise temperature sensors are designed for mounting over the forming line conveyor, starting at the mixer and ending at the knife. One final set temperature sensor is designed with a rugged housing for mounting on the infeed section just prior to the dryer entrance. These sensors are all connected via a single 4-wire communications and power cable that reliably sends temperature data back to the PC.

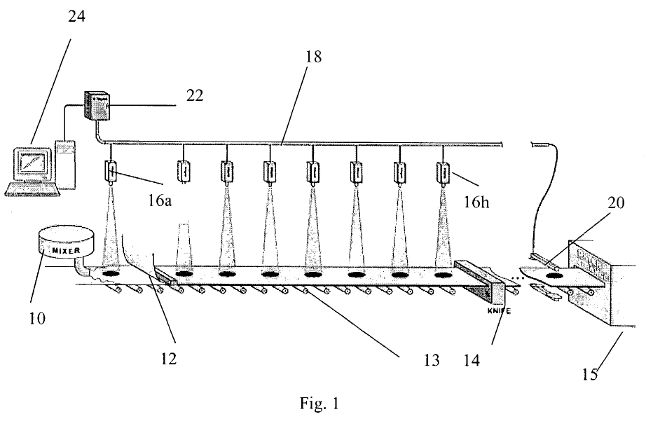

An embodiment of the invention will now be described with reference to FIG. 1. FIG. 1 depicts a system for manufacturing gypsum wall board with an embodiment of the invention employed to monitor the temperature at various physical points of the manufacturing process.

FIG. 1, a slurry mix is output from the mixer 10 onto a paper backing 12 which is transported laterally on a conveyor 13 terminating with a knife 14 for cutting the board at desired intervals. Subsequent to cutting by the knife 14, the board enters a dryer 15. A set of eight IR sensors 16a-h is mounted on a cable tray 18 disposed over the conveyor. A final set temperature measurement sensor assembly 20 mounted on the infeed section just prior to the dryer entrance has a rugged design for reliable use, and continuously monitors the set temperature. A control cabinet 22 receives data from the sensors and provides an input to computer (PC) 24.

Placement of the eight IR sensors 16 over the forming line conveyor 13 starting at the mixer and ending at the knife may be grouped as desired for higher resolution over peak thermal rise sections. The mounting height of the IR sensors 16 over the forming line can be anywhere from 3-to-9 feet (1-to-3 meters). Each sensor is pre-assembled into a sealed enclosure with external terminals for easy mounting and wiring.

In this embodiment, all system sensors are connected via a single 4-wire communications cable, which is mounted in the cable tray 18, that reliably sends temperature data back to the PC 24. Signal control is maintained by the small wall-mountable control cabinet 22 which is designed for placement near the user PC. This cabinet contains the electronic hardware for processing the following signals:

High Alarm Output

Low Alarm Output

Forming Line Speed Analog Input

RS232 Serial PC Connection

IR Sensor Temperature Inputs

The system uses field-proven MID infrared temperature spot sensors, distributed by the assignee of the present application, which are not susceptible to drift, so that no calibration is required once the system has been set up. The only maintenance associated with the system is an occasional air purge to clear any dust particles from the sensor lenses. These lenses are faced downward and are recessed into a ‘peep tube’ to minimize dust problems.

In one embodiment, an OPC option allows the users the flexibility of interfacing software variables generated by the system directly with numerous third-party NMI/HMI/SCADA programs (e.g., Wonderware, Intellution, Siemens, and Rockwell, among others. As is known in the art, OPC (OLE for Process Control) is a standard that defines methods for exchanging real-time automation of data among software clients.

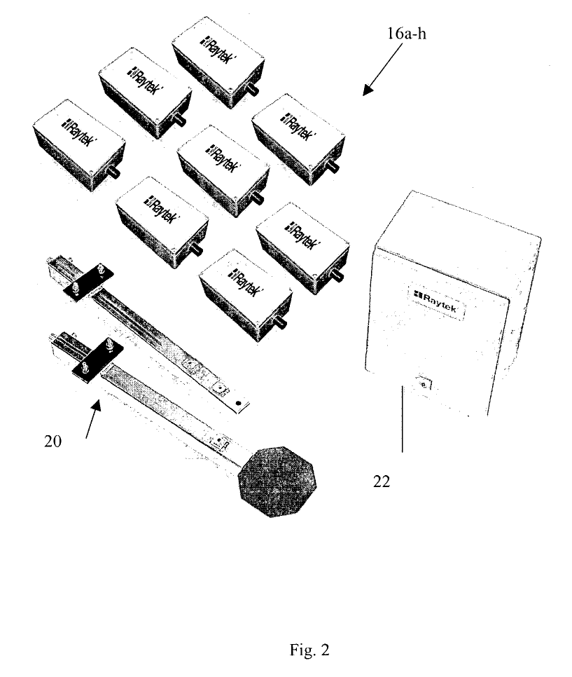

FIG. 2 depicts the hardware included in one embodiment, which includes:

The monitoring system consists of an array of 9 MID sensors communicating via RS485 on a single cable to an RS232 converter. The small wall mountable main panel 22 contains the converter, a 24-volt power supply, 2 opto-coupled alarm relay outputs, field wiring terminals, and a serial output to be connected to the customer's PC.

The 8 forming line MID sensors 16a-h are mounted equidistant from one another over the forming line conveyor section starting at the mixer and ending at the knife. Each of these sensors will be premounted in a plastic box with 4 field wiring terminals. a view port in the bottom.

The 9th (last) sensor is mounted in an environmentally protected, telescoping assembly, which will be installed along with a target assembly on the infeed section just prior to the dryer.

The sensor boxes include a resistive thermal device (RTD) for measuring ambient air temperature.

An embodiment of software for processing data provided by sensors and generating visual displays interpreting the monitored data will now be described.

The following is an overview of an embodiment of the software for processing the inputs from the array:

The monitoring software is a Visual Basic based program that generates a Time/Temperature graph representing the temperatures from the 9 MID sensors. Each sensor point on the graph has an associated hi/lo alarm corridor (which the process should be within).

The software will need to have the following process information: 1) Forming line speed 2) Ambient air temperature 3) Product recipe 4) Customer defined alarm corridors. These parameters will need maintenance level control for offset/calibration of these as well.

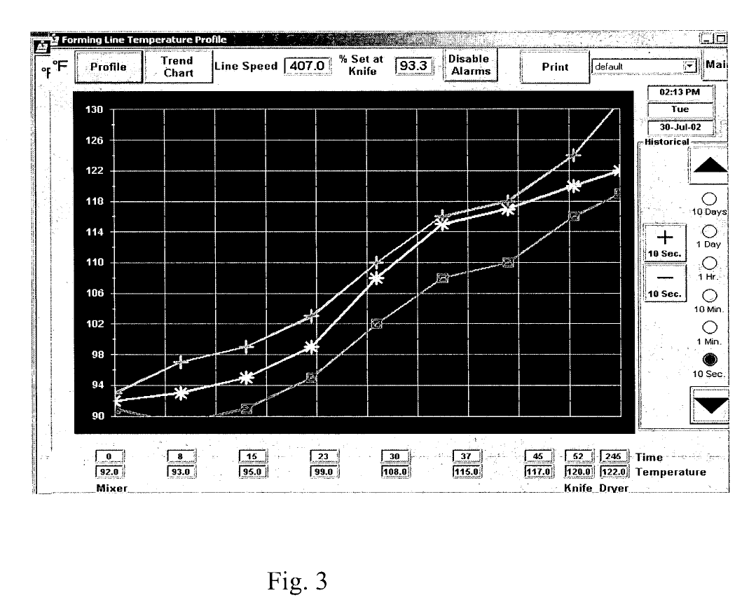

In this embodiment, as depicted in FIG. 3, the software generates a Time/Temperature graph plotting the readings of the eight rise temperature sensors and the one final set temperature sensor—thus reproducing the standard manual temperature rise/set chart in real-time.

Also, each sensor point on the graph has an associated high/low alarm corridor that relates to a target mixer rise/set temperature range, and is automatically activated if the mixer slurry shifts. Thus, for example, if the third sensor were positioned over a temperature critical point in the process it can be programmed with a high/low alarm corridor of 1° above or below a target temperature so that even a slight deviation from the target temperature will trigger an alarm.

Additionally, in this embodiment, the system also allows the user to setup up to 99 different “recipes”. Each stored recipe contains distinct alarm corridor parameters as well as the y-axis temperature scales for both charts.

FIG. 3 depicts the display of a temperature plot. that accurately depicts the actual sensor locations and time from mixer (on the X axis)—thus maintaining accuracy of time/distance and allowing the user to choose the sensor locations over the forming line. Grouping multiple sensors for higher resolution at peak thermal rise sections is therefore allowed. The software utilizes the provided torming line speed and inter-sensor intervals to determine the process time for each measured temperature.

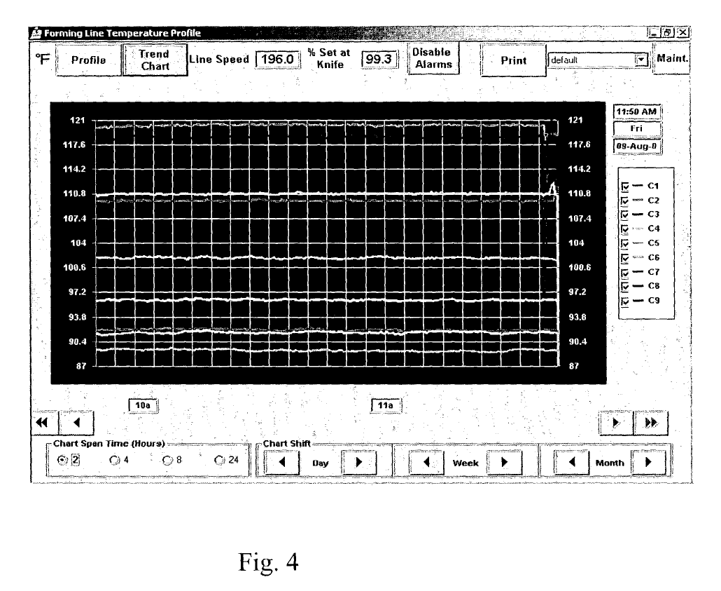

All rise/set profile and trending information is automatically stored and can be reviewed. FIG. 4 depicts a historical trend chart generated and displayed by the software. In addition, a product recipe database stores all recipe specific alarm corridors, and the percent set at knife calculation is displayed on the primary operating screen. Since, in this embodiment, the system software was written in Visual Basic, the end user saves the high cost of a runtime key as compared to HMI software packages.

As described above, the sensors provide the ambient air temperature to the software. Significant air temperature changes can affect the board temperatures down the forming line. In one embodiment, the software includes an ambient air temperature algorithm. The compensation can be individually weighted for each temperature measurement point to allow for localized compensations.

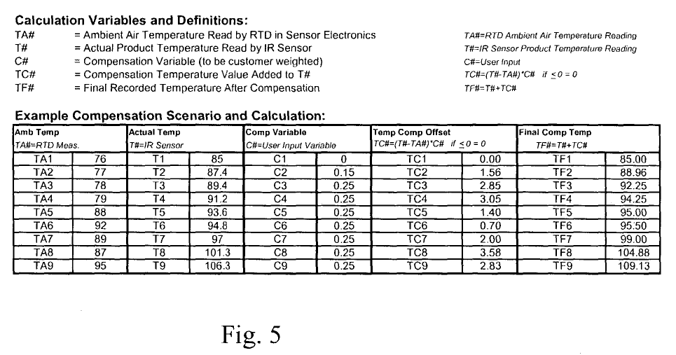

FIG. 5 is a table illustrating the algorithm used in this embodiment to calculate a compensated temperature based on measured actual product and ambient air temperatures and the results for various input values. In this embodiment, the value of a compensation temperature is based on the product of a compensation variable and the difference between actual product temperature (measured by the IR sensor) and the ambient air temperature. The final compensated temperature is equal to the sum of the actual measured temperature and the compensation temperature. FIG. 6 is a graph depicting the values of actual IR temperature, ambient temperature, and compensated temperature.

The invention may be implemented as program code, stored on a computer readable medium, that is executed by a digital computer. The computer readable medium may include, among other things, magnetic media, optical media, electro-magnetic fields encoding digital information, and so on. In the above-described embodiment the software is stored on the hard drive of the PC 24 and executed by the microprocessor of the PC 24.

The above embodiments have been described implemented in a gypsum wall board manufacturing process. However, the invention can be utilized in other continuous web processes that require thermal monitoring. For example, the manufacture of photographic film is a continuous web process. One of the steps in this process includes the convective heat drying of the film. The film is very easily ruined by over- or under-heating at this phase. The manufacturers have traditionally had a very difficult time monitoring the quality control of this step in the process. A system similar to the embodiment described above would allow film manufacturers to automatically monitor and alarm for the time/temperature relationship all the way through the oven section within a very tight specified corridor. In addition, they could use the provided rise/set output signals to automate the temperature adjustments.

The invention has now been described with reference to the preferred embodiments. Alternatives and substitutions will now be apparent to persons of skill in the art. For example, the particular number of sensors and their positioning may be varied. Further, different algorithms for compensating for ambient temperature changes may be utilized. Further, although the software embodiment described is programmed in Visual Basic other programming languages can be utilized. Accordingly, it is not intended to limit the invention except as provided by the appended claims.

What is claimed is:

1. A system for monitoring temperature values of a curing gypsum slurry mixture being transported on a transport mechanism to form wallboard, said system comprising:
a plurality of infrared sensors, with each infrared sensor for measuring the temperature of an object positioned in the field of view of the infrared sensor, and with each infrared sensor positioned to monitor the temperature of the mixture at an associated specific location of the transport mechanism and outputting temperature information indicating the current temperature measured by the infrared sensor; and
a controller, coupled to receive the temperature information output by the plurality of infrared sensors and having a visual output device, for displaying, on the visual output device, the current measured temperature at each specific location of the transport mechanism monitored by one of the plurality of infrared sensors.

2. The system of claim 1, where the controller stores an alarm value and further comprises:
an alarm signal output for asserting an alarm signal when the current temperature measured by one of the infrared sensors is over a high value or under a low value.

3. The system of claim 1 where the controller periodically stores current measured values to maintain a history of a curing process.

4. The system of claim 1 where the transport mechanism has a knife at one end for cutting the wallboard prior to entering a dryer and where:
one of said infrared sensors is positioned to measure the temperature of mixture just prior to entering the dryer.

5. The system of claim 1 where at least one of the sensors provides ambient air temperature information and where:
the controller compensates a current measured temperature based on received ambient air information.

6. The system of claim 1 where the controller is a computer and the infrared sensors output an electrical signal indicating a temperature value, with system further comprising:
an signal interface with inputs coupled to receive the electrical signals and an output coupled to the computer for providing signals compatible with an input of the computer.

7. A computer program product for use on a system including a digital computer that monitors temperature values of a curing gypsum slurry mixture being transported on a transport mechanism to form wallboard, with computer receiving temperature information from a plurality infrared sensors, with each infrared sensor positioned to monitor the temperature of the mixture at an associated specific location of the transport mechanism and providing temperature information indicating the current temperature measured by the infrared sensor to the computer, the computer program product comprising:
a computer usable medium having computer readable program code physically embodied therein, said computer program product further comprising:
computer readable program code for causing the computer to display a real-time temperature rise/set chart.

8. The computer program product of claim 7 where the computer stores alarm corridor information for a least one displayed temperature, and further comprises:
computer readable program code for causing the computer to output an alarm signal if a computed temperature value falls outside an alarm corridor.

9. The computer program product of claim 7 where the computer receives ambient temperature information, and further comprises:
computer readable program code for causing the computer to calculate and display compensated temperature values based on received ambient temperature.

10. A system for monitoring temperature variations over time and in different locations of a workpiece formed by a manufacturing process carried out over a spatial region for a duration of time, said system comprising:
a plurality infrared sensors, with each infrared sensor for measuring the temperature of an object positioned in the field of view of the infrared sensor; and with each infrared sensor mounted to monitor the temperature of a part of the workpiece located at an associated specific region of the manufacturing process and outputting temperature information indicating the current temperature measured by the infrared sensor; and
a controller, coupled to receive the temperature information output by the plurality of infrared sensors and having a visual output device, for displaying, on the visual output device, the current measured temperature of the workpiece at each specific region of the process monitored by one of the plurality of infrared sensors.

11. The system of 10, where the controller is programmed stores an alarm value and further comprises:
an alarm signal output for asserting an alarm signal when the current temperature measured by one of the infrared sensors is over a high value or under a low value.
